(19) United States
(12) Patent Application Publication
(10) Pub. No.: US 2020/0001773 A1
(43) Pub. Date: Jan. 2, 2020

(54) METHOD AND DEVICE FOR MANUFACTURING AN OPTICAL ASSEMBLY

(71) Applicant: BCS AUTOMOTIVE INTERFACE SOLUTIONS GMBH, Radolfzell (DE)

(72) Inventor: ULRICH BACKES, Radolfzell (DE)

(21) Appl. No.: 16/453,325

(22) Filed: Jun. 26, 2019

(30) Foreign Application Priority Data
Jul. 2, 2018 (DE) 102018115967.6

(51) Int. Cl. B60Q 1/08

(52) U.S. Cl. CPC B60Q 1/085; B60Q 2300/314

(57) ABSTRACT

In a method of manufacturing an optical assembly for a light sensor, in particular for a rain sensor for a motor vehicle, which comprises a lens plate and a shadow mask attached to the lens plate, a bundle of light beams is first generated. The bundle of light beams is focused on a partial area of a shadow mask blank attached to the lens plate, and a through opening is burned into the shadow mask blank by means of the bundle of light beams.

The invention relates to a method of manufacturing an optical assembly for a light sensor, and to an arrangement for manufacturing an optical assembly for a light sensor.

### BACKGROUND TO THE INVENTION

Typical light sensors (as used in rain sensors for motor vehicles, for example) known from the prior art include a lens plate having at least one converging lens and at least one light receiving unit. The converging lens focuses light lying within a range of acceptance angles around a main receiving direction onto the light receiving unit.

A small light receiving unit and at the same time an exact relative positioning of the converging lens and of the light receiving unit are necessary, in particular for applications of the light sensor that require a small range of acceptance angles, as a result of which the manufacture of the light sensor is more complicated and/or cost-intensive.

Therefore, the object of the invention is to provide a method and an arrangement for manufacturing an optical assembly for a light sensor which improve the drawbacks of the prior art.

### BRIEF DESCRIPTION OF THE INVENTION

According to the invention, the object is achieved by a method of manufacturing an optical assembly for a light sensor, in particular for a rain sensor for a motor vehicle, comprising a lens plate and a shadow mask attached to the lens plate, comprising the following steps: first, a bundle of light beams is generated. The bundle of light beams is focused on a partial area of a shadow mask blank attached to the lens plate, and a through opening is burned into the shadow mask blank by means of the bundle of light beams.

The optical assembly obtained by means of the method according to the invention has a defined range of acceptance angles, since only light incident on the lens plate from a specific range of angles around the direction of incidence of the bundle of light beams can pass through the through opening. Light incident on the lens plate outside this range of acceptance angles is absorbed by the shadow mask (shadow mask blank having a burnt-in through opening). Since the directional pattern and the range of acceptance angles of the optical assembly are already defined by the through opening, a relatively large light receiving unit can be used for the light sensor, which is less sensitive to positioning errors due to its size. Therefore, a relative positioning of the light receiving unit and of the converging lens is facilitated, and the costs for the manufacture of the optical assembly (and thus of the light sensor) are reduced.

In particular, a wavelength of the light in the bundle of light beams lies in a range in which a material constituting the lens plate is substantially transparent, in particular transparent, and in which a material constituting the shadow mask blank is substantially non-transparent, in particular non-transparent, preferably absorbent. Accordingly, the lens plate absorbs no or only little energy when the bundle of light beams passes through the lens plate, while the shadow mask blank absorbs substantially the entire energy of the bundle of light beams, in particular the entire energy.

According to one embodiment of the invention, the bundle of light beams runs substantially along a desired main receiving direction of the optical assembly, in particular along the desired main receiving direction of the optical assembly. The through opening burnt into the shadow mask blank then defines a range of acceptance angles of the optical assembly that lies around the desired main receiving direction. By means of the method according to the invention, optical assemblies having different main receiving directions can be manufactured in a simple manner by simply varying the direction of incidence of the generated bundle of light beams onto the lens plate.

The bundle of light beams can consist of substantially parallel, in particular parallel, converging or diverging light beams.

One aspect provides that the bundle of light beams is focused by means of a converging lens integrated into the lens plate. Therefore, no further optical components are required to focus the bundle of light beams, as a result of which the costs are reduced.

Preferably, the bundle of light beams is a bundle of laser beams. Laser light is particularly suitable for the method according to the invention for several reasons. On the one hand, the light generated is substantially monochromatic, in particular monochromatic, so that a wavelength can be easily selected at which the lens plate is substantially transparent, in particular transparent, while the shadow mask blank is absorbent. On the other hand, light power densities which are required to burn a through opening into the shadow mask can be achieved particularly easily by means of the lasers known from the prior art.

According to a further aspect, an intensity of the bundle of light beams is measured on a side of the shadow mask blank facing away from the lens plate.

The intensity measured is a measure of the size of the through opening, so that the measuring of the intensity permits a very easy determination when the through opening has reached a desired size. The intensity is in particular measured by means of a light receiving unit, which can also be the light receiving unit of the light sensor.

In one development of the invention, a power density of the bundle of light beams is varied based on the measured intensity. If, for example, the measured intensity exceeds a predefined limiting value (which is the case when the burnt-in through opening has reached a desired size), no bundle of light beams is generated, or at least a power density of the bundle of light beams is significantly reduced. Power density is to be understood as an energy flow per area and time. In other words, an intensity of the generated bundle of light beams is thus varied.

A further aspect provides that the method of manufacturing an optical assembly for a light sensor is a method of manufacturing an optical assembly for a rain sensor of a motor vehicle.

Accordingly, the desired main receiving direction can be that direction in which a light receiving means of the rain sensor is to be sensitive to light incidence.

According to the invention, the object is further achieved by an arrangement for manufacturing an optical assembly for a light sensor, in particular for a rain sensor for a motor vehicle, having a light generating means, a lens plate and a shadow mask blank attached to the lens plate, wherein the light generating means is configured to generate a bundle of light beams, wherein the lens plate comprises at least one converging lens, and wherein the shadow mask blank is arranged at least in sections substantially in a focal point of the at least one converging lens, in particular in the focal point of the at least one converging lens.

With regard to the advantages of claims 7 to 11, reference is made to the above explanations.

One aspect provides that the light generating means is configured to generate laser light.

In a further development of the invention, the light generating means is arranged such that a main emission direction of the light generating means corresponds to a desired main receiving direction of the optical assembly.

According to a further aspect, a light receiving unit is provided on a side of the shadow mask blank facing away from the light generating means. It is in particular a light receiving unit of the light sensor to be manufactured.

The light receiving unit can be connected in a signal transmitting manner to a controller which is configured to control the light generating means. Preferably, the controller is configured to adjust the power density of the bundle of light beams fully automatically, in particular based on an intensity of the bundle of light beams measured using the light receiving means.

A further aspect provides that the arrangement for manufacturing an optical assembly for a light sensor is an arrangement for manufacturing an optical assembly for a rain sensor of a motor vehicle.

Accordingly, the desired main receiving direction may be that direction in which a light receiving means of the rain sensor is to be sensitive to light incidence.

### BRIEF DESCRIPTION OF THE DRAWINGS

Further advantages and characteristics of the invention will become apparent from the description below and from the drawings to which reference is made and which show:

FIG. 1 schematically a cross-section through an arrangement according to the invention for the manufacture of an optical assembly; and

FIG. 2 the arrangement of FIG. 1 in a modified variant.

### DETAILED DESCRIPTION OF THE INVENTION

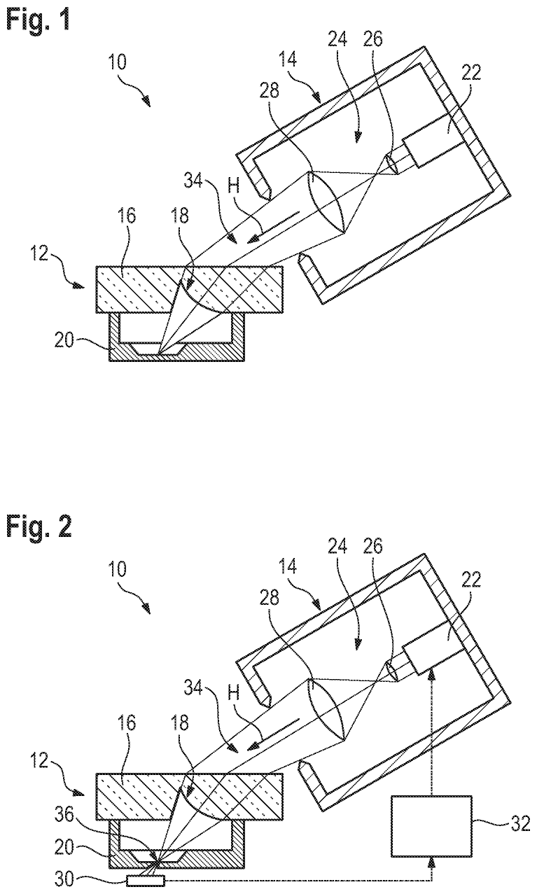

FIG. 1 shows an arrangement 10 for manufacturing an optical assembly. The arrangement 10 comprises a blank 12 of the optical assembly and a light generating means 14.

The optical assembly to be manufactured from the blank 12 is an optical assembly for a light sensor as used for example in rain sensors for motor vehicles. An optical assembly for a light sensor having a narrow range of acceptance angles is in particular involved.

The blank 12 includes a lens plate 16 having an integrated converging lens 18.

In addition, the blank 12 comprises a shadow mask blank 20 which is attached to the lens plate 16 such that the shadow mask blank 20 is arranged at least in sections in a focal point of the converging lens 18.

The light generating means 14 comprises a light source 22 and a light concentrating means 24, which in the variant shown in FIGS. 1 and 2 consists of two optical lenses 26, 28.

Preferably, the light source 22 is a laser light source. More preferably, the light source 22 generates laser light in a wavelength range in which the lens plate 16 is substantially transparent, in particular transparent, but the shadow mask blank is substantially non-transparent, in particular non-transparent, more precisely absorbing.

Alternatively, the light source 22 can also be configured to generate other light which is suitable for the method described below.

FIG. 2 shows a slightly modified variant of the arrangement of FIG. 1, in which a light receiving unit 30 and a controller 32 are additionally provided, the controller 32 being connected to the light receiving unit 30 and to the light generating means 14 in a signal transmitting manner (indicated in FIG. 2 by the dotted lines), in particular to the light source 22.

The light receiving unit 30 is arranged on a side of the lens plate 16 facing away from the light generating means 14.

A method of manufacturing an optical assembly by means of the arrangement 10 according to FIG. 1 or FIG. 2 is explained below.

First, a bundle of light beams 34 is generated using the light generating means 14. To this end, light emitted by light source 22 is brought into a desired shape using the light concentrating means 24. In particular, the light generating means 14 generates a parallel, converging or diverging bundle of light beams 34.

The generated bundle of light beams 34 runs substantially along a desired main receiving direction H of the optical assembly to be manufactured, in particular along the desired main receiving direction H of the optical assembly to be manufactured.

The desired main receiving direction H may be that direction in which the light receiving means 14, when installed in a rain sensor, is to be sensitive to light incidence.

The bundle of light beams 34 enters the lens plate 16 and is focused by means of the integrated converging lens 18 onto a part of the shadow mask blank 20 which is arranged in the focal point of the converging lens 18. Since the material of which the lens plate 16 consists is substantially transparent, in particular transparent to the laser light, the bundle of light beams 34 passes through the lens plate 16 substantially without any energy release.

However, the material of which the aperture mask blank 20 is made absorbs the bundle of light beams 34, so that a through opening 36 (see FIG. 2) is burnt into the shadow mask blank 20.

Optionally, as shown in FIG. 2, the light receiving unit 30 is used to measure an intensity of the light passing through the through opening 36. An appropriate measuring signal is transmitted to the controller 32.

The controller 32 can control the light receiving means 14, in particular the light source 22 based on the measured intensity. More precisely, a power density of the bundle of light beams 34 generated by the light generating means 14 is varied depending on the measured intensity.

For example, if the measured intensity exceeds a predefined limiting value (which is the case when the burnt-in through opening 36 is large enough), it can be provided that the controller shuts down the light source 22 or at least significantly reduces the power of the light source 22.

The optical assembly obtained by means of the method described above has a narrow range of acceptance angles since only light incident on the lens plate 16 from a specific range of angles around the main receiving direction H can pass through the through opening 36. However, light incident on the lens plate 16 outside the range of acceptance angles is absorbed by the shadow mask (shadow mask blank 20 having a burnt-in through opening 36).

Since the directional pattern and the range of acceptance angles of the optical assembly are already defined by the through opening 36, a relatively large light receiving unit can be used for the light sensor. In particular, this involves the light receiving unit 30 described above.

1. A method of manufacturing an optical assembly for a light sensor, in particular for a rain sensor for a motor vehicle, comprising a lens plate and a shadow mask attached to the lens plate, comprising the following steps:
generating a bundle of light beams;
focusing the bundle of light beams onto a partial area of a shadow mask blank attached to the lens plate; and
burning a through opening into the shadow mask blank by means of the bundle of light beams.

2. The method according to claim 1, characterized in that the bundle of light beams runs substantially along a desired main receiving direction of the optical assembly, in particular along the desired main receiving direction of the optical assembly.

3. The method according to claim 1, characterized in that the bundle of light beams is focused by means of a converging lens integrated into the lens plate.

4. The method according to claim 1, characterized in that the bundle of light beams is a bundle of laser beams.

5. The method according to claim 1, characterized in that an intensity of the bundle of light beams is measured on a side of the shadow mask blank facing away from the lens plate.

6. The method according to claim 5, characterized in that a power density of the bundle of light beams is varied based on the measured intensity.

7. An arrangement for manufacturing an optical assembly for a light sensor of a, in particular for a rain sensor for a motor vehicle, having a light generating means, a lens plate and a shadow mask blank attached to the lens plate, wherein the light generating means is configured to generate a bundle of light beams, wherein the lens plate comprises at least one converging lens, and wherein the shadow mask blank is arranged at least in sections substantially in a focal point of the at least one converging lens, in particular in the focal point of the at least one converging lens.

8. The arrangement according to claim 7, characterized in that the light generating means is configured to generate laser light.

9. The arrangement according to claim 7, characterized in that the light generating means is arranged such that a main emission direction of the light generating means corresponds to a desired main receiving direction of the optical assembly.

10. The arrangement according to claim 7, characterized in that a light receiving unit is provided on a side of the shadow mask blank facing away from the light generating means.

11. The arrangement according to claim 10, characterized in that the light receiving unit is connected in signal transmitting manner to a controller which is configured to control the light generating means.
